(19) United States
(12) Patent Application Publication
(10) Pub. No.: US 2011/0295504 A1
(43) Pub. Date: Dec. 1, 2011

(54) MOISTURE DETECTION WIRE, A MOISTURE DETECTION SYSTEM, AND A METHOD OF DETECTING MOISTURE

(76) Inventors: Kenneth Willis Barber, Victoria (AU); Graeme Alexander, Victoria (AU); Michael Fielding, Victoria (AU); James Mullins, Victoria (AU)

(21) Appl. No.: 13/063,893

(22) PCT Filed: Oct. 22, 2009
(86) PCT No.: PCT/IB2009/055231

§ 371 Date: Jun. 22, 2011

(30) Foreign Application Priority Data
Oct. 24, 2008 (AU) 2008905535
Jun. 10, 2009 (AU) 2009902662

(51) Int. Cl. G06F 19/00; C08L 31/04; C08L 77/06; C08L 29/04

(52) U.S. Cl. 702/3; 525/58

(57) ABSTRACT

A water detector wire 1.002 for use in a power cable or building, the cable having a wire 1.004 with a water soluble insulating jacket 1.006 made of two or more components, wherein a first component has a first solubility in water, and the second component has a second solubility in water, the second solubility being less than the first solubility. The second component can be substantially insoluble. On exposure to water, the soluble insulation 1.006 dissolves at the location of the water exposing the wire 1.004. This can be detected when the wire is close to a return path such as a return wire 4.038 or a cable screen 13.232. The location of a fault can then be detected by measuring the linear resistance of the wire. Two such wires 3.006, 3.007 can be used together.

### FIELD OF THE INVENTION

This invention relates to the detection and location of moisture.

The invention is particularly suited for detection of moisture, and can be adapted for use in detecting unwanted moisture in buildings or for use in detecting unwanted ingress of water into electrical and communication cables and the like. In particular the invention provides a water detection cable and a water detection system.

### BACKGROUND OF THE INVENTION

The detection of unwanted water ingress can be important in a number of situations. The invention will be described in the context of detection of water ingress in electrical power cables, and in another context, that of water ingress into buildings.

In the context of underground cables, where cables have been correctly installed there is a very low risk of cable failure because the cables were have been tested after manufacture at well above their working voltage. Similarly with modern accessories and correctly trained personnel the risk of failure is limited.

However, there are a number of causes of cable failure, including damage during installation and faulty workmanship during installation of the cable and accessories.

However the most common are more likely to be as a result of inadequate protection of the cable and accessories in service; environmental conditions; third party external damage; and thermal overload due to inappropriate loading often due to proximity with other services or changed environmental factors.

The presence of water in high voltage XLPE (cross-linked polyethylene) insulated cables can result in the growth of water trees in the insulation, and this can lead to electrical trees which can result in failure of the insulation. To retard this process, moisture barrier sheaths, such as lead and other metal extrusions or the use of water blocking powder, yarns, threads or tapes can be interspersed in the interstices within the cable. Such measures are intended to prevent the longitudinal spread of water which may enter the cable though a damaged section of the insulation or a faulty join in the insulation, for example, at a cable junction.

However, it is also important to detect the occurrence of such water ingress, preferably before the cable fails.

U.S. Pat. No. 7,102,076 describes a water sensing cable having a conductor surrounded by a permeable insulation, which, when wet, allows conduction of a signal. The sheath is typically braid, and this involves complex and expansive construction. When the water has dried, the location of the leak can not be detected.

Tatsua Electric Wire & Cable Co., Ltd provides a water leakage detector system for detecting water ingress in buildings. This system uses a conductor with a jacket which, when wet detects the presence of moisture, and which returns to its original insulative condition once it dries out. The jacket is plastic yarn braid. The sensor cable can be up to 100 m long. One form of the water detector wire changes colour when wet, and retains the colour change when dry.

JP187841 & JP6187842 describe a water detection cable for use with a telecommunication cable. The specification describes a detector wire having a copper conductor with a single, thin, 8 μm layer of cellulose ether applied by repeatedly dipping the conductor in a solution of 2% cellulose ether in a water/alcohol solvent to build up the soluble layer. This process is slow and inefficient. In addition, the coating disclosed in the specifications of JP187841 & JP6187842 is not suitable for use in situations where low levels of moisture can be tolerated, such as power cables or buildings, because it is too sensitive to moisture and may generate premature fault indications. An alternative material disclosed in JP6187842 is “partly saponificated polyvinyl alcohol”. JP187841 & JP6187842 do not describe an extrudable soluble sheathing material. These documents describe the use of an organic, or semi-organic, material which is subject to fungal growth. Accordingly the specification requires the addition of fungicide to the soluble insulation.

It is desirable to provide a more efficient process for manufacturing a water detector wire.

It is desirable to have a water detector wire with a soluble coating in which the solubility is modified.

It is desirable to provide a water detection wire and system which can provide location of the water ingress when the water is no longer present.

In the context of unwanted water ingress into buildings, such as buildings which are remote or infrequently used, or buildings in which expensive equipment, such as computers are housed, the detection of moisture ingress is also important.

In both instances, it is also desirable to determine with good proximity, the location of the point of water ingress.

### SUMMARY OF THE INVENTION

This invention is based, among other insights, on the different requirements for moisture detection systems in different applications. For example, the effects of moisture ingress in telecommunication cables are different from the effects of moisture penetration into power cables. Telecommunication cables are more sensitive to moisture ingress as the resulting noise can corrupt the information signals, while power cables can tolerate moisture for longer periods. Accordingly, a water detection cable for a power cable needs to be specifically adapted for such an application.

Similarly, in building water ingress detection, it may not be desired to detect minor condensation, but it may be imperative to detect large scale ingress of water.

Accordingly, the invention contemplates a water-soluble material as the insulation of a moisture sensing cable, the material including two or more components, and at least a first component and a second component, wherein the first component has a first solubility in water and the second component has a lower solubility than the first component, or is insoluble in water.

The second component can act as a solubility modifier for the material.

The second component can be substantially insoluble in water.

The ratio of the first and second components can be adjusted to control the overall solubility of the material.

The modifier can be nylon.

The modifier can be a plastics or polymer material.

The modifier can have a higher molecular weight than the first component.

The soluble material can be polyvinyl alcohol (PVA).

The second component can be polyvinyl acetate.

The material can be formed without plasticizer.

Preferably, the material can be applied without fungicide.

The material can be extrudable.

The material can have two or more soluble components.

The material can have at least one soluble component, and two or more insoluble components.

The material can include a mixture or blend of nylon and polyvinyl alcohol.

The polyvinyl acetate can be less than 5% by weight of the mixture.

The polyvinyl acetate can be 0.02%.

The PVA can comprise between 75% and 98% by weight of the material.

The PVA can be 99.9%.

The PVA can comprise more than 95% by weight of the material.

According to an embodiment of the invention, there is provided a moisture detection wire including at least a first wire having a water soluble coating including at least a first material and a second material, the solubility of the second material being less than the solubility of the first material.

The cable can include a proximate second conductive path.

The detection cable can include first and second wires, the wires being coated with a water soluble material as described above, the coated wires being in close proximity.

The coated wires can be twisted together.

The wire can be a stainless steel wire.

The wire can be adapted for incorporation into a high voltage cable.

The wire can be adapted for use in a building water ingress detection system.

According to an embodiment of the invention, a detector circuit includes a signal source and a detector connected to a sensor wire circuit. The signal can be applied periodically, intermittently, or in response to a user input.

The signal source can be a DC source.

The detector can be a DC bell or visual alarm, such as a light emitting diode.

According to another aspect of the invention, there is provided a moisture ingress detection system including:

one or more moisture detection cables having soluble insulation;
a signal source connectable to the detector cable to apply a measurement signal to the detector cable;
a monitor including impedance measuring means (7.032) to periodically or continuously measure the impedance of the wire;
memory means (5.051) containing previous impedance measurements;
processor means (5.040) to determine whether the current measurement is within predetermined limits.

The monitoring system can include comparison means comparing a current impedance measurement with a previously stored value.

The processor means can be programmed to calculate the location of a low impedance fault 7.066 on the insulated wire.

The monitoring system can include an impedance bridge to which the detector wire and the impedance measuring means are connected.

The measuring means can include a successive approximation analog-to-digital converter.

The layout of the cable can be mapped to correspond to specific locations in a building.

The monitor system includes distance estimation capabilities to estimate the distance to a fault in the cable.

The detector wire can be formed in detachable segments corresponding to physical locations.

The monitor can use high resolution successive approximation analog-to-digital conversion (ADC) to measure the impedance.

The detector wire can have one or more bypass zones in which the insulation is not water soluble.

The locations of the bypass zones can be programmed into the monitor.

The monitor apparatus can include distance estimation capabilities.

The monitor can track long term changes in the insulation.

The monitor can determine average readings over a period of time.

The condition of the detector wire can be assessed from analysis of the slope of the time average of the measurements.

The distance estimation can be performed by comparison of measured resistance values or of a measured resistance value and a calculated resistance value.

The monitor can be programmed to disregard error indications from a predetermined or pre-programmed zone of the detector wire.

The system can be programmed to detect at least one non-zero resistance fault, and one zero resistance fault.

The system can be calibrated by taking one or more measurements when the detector wire is operating at a low or minimum operating temperature.

The test voltage can be from 10 v to 2000 v.

The test voltage can be between 10 v & 500 v.

The test voltage can be between 10 v and 50 v.

The test voltage can be DC.

The monitor can include a warning device.

The invention also provides a method of monitoring a location for the presence of water including the steps of deploying a detector wire having water soluble insulation in the location, and periodically or continuously monitoring the impedance of the detector wire, and comparing each impedance measurement with a previous impedance value, and analysing the result of the comparison to determine whether the wire has a region of reduced insulation.

The invention also provides a method of determining the location of water in contact with an electrical path including one or more wires with a soluble coating, the method including the steps of repeatedly measuring the resistance of the cable, comparing resistance measurements, detecting a drop in resistance, and providing a fault indication when the resistance falls below a threshold value.

The threshold value can be determined from the resistivity of the wire at its lowest environmental temperature.

The method can include calculating the ratio of the post fault resistance with the pre-fault resistance, and proportioning the length of the cable by the ratio to determine the location of a leak.

The step of measuring the resistance can be carried out repeatedly, the value being stored for comparison with subsequent measurements.

The invention further provides a system for determining the presence of water in a cable, the system including a test signal generator adapted to be connected to the cable, a detector adapted to monitor a characteristic of the cable when a test signal is applied to the cable.

The system can include means for adjusting the monitored characteristic in response to a second variable.

The second variable can be temperature.

In the case of a cable subject to substantially uniform temperature environment, the resistance per metre will vary uniformly with changes in temperature, there being a positive correlation between the resistance and the temperature for most metals.

The system can include a processing means responsive to the detector to provide an indication of the presence of a fault.

The processing means can be adapted to provide an indication of the location of a fault in the cable.

The invention also provides a method of determining the location of water in a cable including the steps of making an initial measurement of the resistance of a measuring wire and a return path in a cable in situ, and making one or more subsequent measurements of the resistance, and comparing the subsequent measurements with the initial measurement to identify changes in the resistance.

The method can include the step of measuring the resistance of the detector wire, and where the resistance is below a predetermined value, providing a fault indication.

The method can include the steps of determining the unimpaired initial resistance of the detector wire, measuring the resistance of the detector wire affected by water ingress, and calculating a distance estimate to a location when the subsequent resistance value is less than the initial resistance value.

The method can also include the step of adjusting the measurements to allow for variation in temperature.

### BRIEF DESCRIPTION OF THE DRAWINGS

Embodiments of the present invention will now be described, by way of example only, with reference to the accompanying drawings, in which:

FIG. 1 is a schematic illustration of a section of water detection cable according to an embodiment of the invention.

FIG. 2 is a schematic illustration of a section of water detection cable according to an embodiment of the invention.

FIG. 3 shows a detector wire according to an embodiment of the invention.

FIG. 4 is a schematic illustration of a water detection arrangement according to an embodiment of the invention.

FIG. 5 is a schematic illustration of a monitor according to an embodiment of the invention.

FIG. 6 is a schematic illustration of a detector box into which the monitor of FIG. 5 can be assembled.

FIG. 7 illustrates a schematic view of a sensor wire with part of the insulation dissolved.

FIG. 8 schematically illustrates a sensor wire with a processor and a terminating impedance.

FIG. 9 schematically illustrates a monitor system including a bypass section.

FIG. 10 illustrates a method of operating a water monitoring system in accordance with an embodiment of the invention.

FIG. 11 is a detailed flow diagram of a method according to an embodiment of the invention.

FIGS. 12, 13, & 14 schematically illustrate cable arrangements including water detection wires according to embodiments of the invention.

FIG. 15 is an illustration of a section of a single core cable with a water sensing wire in the screen.

The numbering convention used in the drawings is that the digits in front of the full stop indicate the drawing number, and the digits after the full stop are the element reference numbers. Where possible, the same element reference number is used in different drawings to indicate corresponding elements.

### DETAILED DESCRIPTION OF THE EMBODIMENTS

The invention will be described with reference to the embodiments shown in the drawings. In a first arrangement, a water ingress cable is adapted to be deployed in a building, and in a second arrangement, a water sensing wire or cable is adapted for incorporation in a power cable. In both arrangements, monitor equipment can be attached to the water detecting wire to calculate the location of the point of contact between the detector wire and the water.

The preferred soluble material is polyvinyl alcohol (PVA.) PVA is not suitable for extrusion because its melting point is about the same as its decomposition point. Accordingly we use a mixture of PVA and polyvinyl acetate. This has the added advantage that the solubility of the mixture is lower than for PVA on its own. We use Kuray POVAL CP-1000 and CP-1210. The proportion of PV Alcohol to PV Acetate can vary from 25/8-to 85/25. Preferably, the proportion of PV Acetate is between 35% and 70%.

PVA can be made from polyvinyl acetate. Polyvinyl acetate is practically insoluble in water. Polyvinyl acetate can be wholly or partially converted to PVA, and can be manufactured in different proportions of PVA/polyvinyl acetate. Polyvinyl acetate is hygroscopic, and swells in the presence of water.

The formulae for the two polymers are:

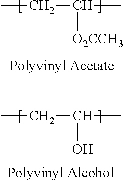

The inventive system can be implemented using a combination of PVA/polyvinyl acetate mixture with the required solubility. This mixture can be extruded onto a sensing wire.

In one embodiment of the invention, PVA or a PVA/polyvinyl acetate can be mixed with other material such as nylon to provide a jacket with reduced solubility compared with PVA while incorporating some of the characteristics of nylon. Similarly, polymer materials with desirable characteristics can be substituted for nylon. The weight percentage of nylon can be from 40% to 80%, the bulk of the remainder being the soluble PVA or PVA and polyvinyl acetate.

The invention will be described with reference to the embodiments illustrated in the drawings.

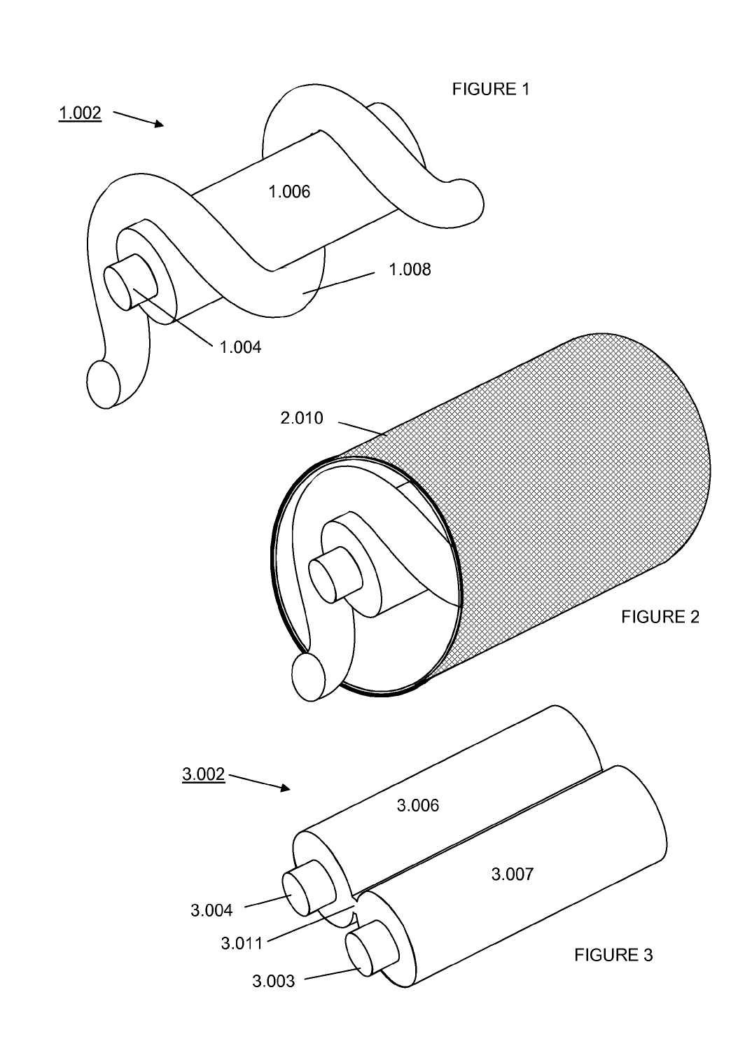

FIG. 1 is a schematic illustration of a segment of a detector wire arrangement 1.002 according to an embodiment of the invention.

The detector wire arrangement includes a sensor wire 1.004 enclosed in an insulating jacket 1.006. The insulation can have two or more components, at least one of which is soluble. The soluble component of the insulation can be made of a soluble material such as a polymer composition including a proportion of vinyl alcohol/vinyl acetate copolymer or polyvinyl acetate as the soluble component. The degree of solubility can be adjusted by adjusting the proportion of soluble component. The insulation can be formed without plasticizer. The insulation can be adapted to substantially dissolve when exposed to moisture or to water.

The wire can be made of any suitable material such as stainless steel. The sensor wire 1.004 can have a higher resistance than a normal electrical conductor wire.

The wire can be pre-treated before extruding the soluble insulation onto the wire to help ensure that the insulation is free of cavities and has good adherence. Thus the wire can be pre-heated to about the melting temperature of the extrudate. This can be done immediately before the wire enters the extruder. Alternatively or additionally, the insulated wire can be heat treated to reduce stress in the insulation after extrusion.

The sensor wire 1.004 is deployed in close proximity to a return conductor 1.008. In the embodiment shown, the return conductor is a wire is wound around the sensor wire insulation 1.006. However, different configurations of the sensor wire and return conductor are within the scope of the invention.

The return wire 1.008 can be made of any suitable conductive wire, or it can be made of the same material as the sensor wire.

As will be discussed below, the wire can be made to the required length and deployed in areas where it is desired to detect the ingress of water or excessive moisture and connected to monitoring equipment adapted to determine the distance along the cable where the insulation has failed.

Alternatively, the wire can be made in discrete segments with complementary connectors at either end, so a number of segments can be connected in series.

FIG. 2 is a schematic illustration of a cable including a sensor wire arrangement such as that illustrated in FIG. 1, with an outer jacket 2.010. The outer jacket is insulating and permeable to water.

FIG. 3 shows a further embodiment of the invention in which both wires are insulated with a soluble jacket. The two wires 3.004, 3.003 are formed with a soluble insulation jacket 3.005, 3.007. They can be co-extruded. The insulation jackets can be joined, as shown at 3.011. Thus the sensing wires can have a substantially FIG. 8 cross section.

In a further modification, both wires can be sensor wires, ie, both can be made of a higher resistivity wire.

In a further embodiment, two independent wires with soluble insulation can be twisted together using known techniques.

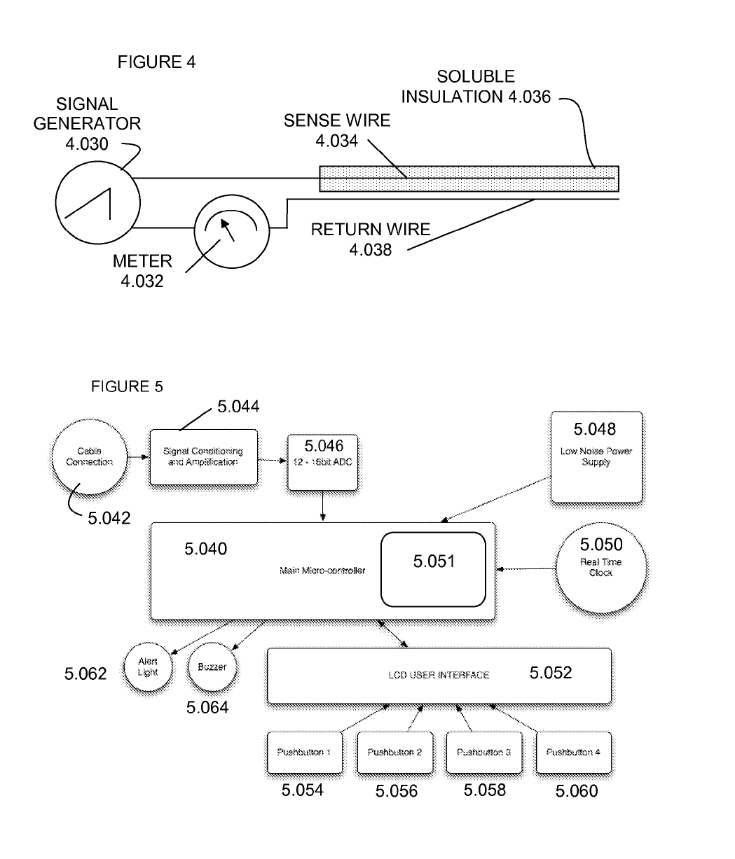

FIG. 4 schematically illustrates a moisture detection system according to an embodiment of the invention.

The system includes a signal generator 4.030, and a signal detector 4.032. The generator can be, for example, a DC voltage source which is continuously applied to the sensor wire 4.034 and return wire 4.038. In this example, the detector is a current meter whose output, together with the input signal voltage, can be used to calculate the resistance of the circuit including the sensing wires and return wire.

When the insulation is dry and intact, no current flows, and the resistance is nominally infinite.

However, if the insulation is dissolved, the sensing wire 4.034 and the return wire 4.038 can come into contact, and will thus produce a closed circuit having the resistance of the length of the sensor wire and return wire up to the point where the insulation has dissolved. Thus, if the resistivity of the wires is known, the distance along the cable to the fault can be calculated, assuming the contact resistance to be negligible. A chart converting current to distance for a given voltage can be provided or the calculation can be made using Ohm's Law to calculate the resistance R from the voltage V and the current I, and the distance L can be calculated from the linear resistance of the wire p (Ohms/m) and the measured resistance R. Thus,

R=V/I (1)

L=R/p (2)

The term “linear resistance” is used herein to refer to the resistance of the sensor wire per metre in Ohms/m.

Thus, if the deployment of the sensing wire has been mapped, so that specific distances along the sensing wire correspond to specific locations, the area in which the leak occurred can be determined.

A processor or other calculating means can be used to calculate the distance L from the above equations.

Other signal sources can be used. For example, time varying signal generator, such as a pulse generator, or a triangular pulse generator, or an alternating signal generator can be used in conjunction with a compatible detector.

FIGS. 5 & 6 illustrate a monitor according to an embodiment of the invention. The sensor wire is connected to the cable connector 5.042 which can be a socket for a two ring plug, or individual wire connectors 6.041, 6.043. A signal conditioning and amplifying circuit 5.044 receives its input from the sensor wire connector 5.042 and the output of the signal conditioning and amplifying circuit is applied to an analog-to-digital converter (ADC) 5.046, which, in turn, is connected to a micro-controller 5.040 which continually compares the resistance, and, when a fault is detected by a drop in resistance, calculates the distance of the fault along the cable.

The signal conditioning and amplification circuit can include an impedance bridge.

The ADC 5.046 can be, for example, a high resolution successive approximation ADC.

The microcontroller can have a memory 5.051 for storing information and measurements of, for example, fault indications, fault location calculations, calibration information, time and date information, and long term impedance measurements.

When a fault is detected, an alarm output is generated, and this can be signalled via an alert light 5.062, which can be a flashing light, and/or a buzzer 5.064.

The user interface can be provided by pushbuttons 5.054, 5.056, 5.058, 5.060 and a visual display 5.052. While the pushbuttons are shown schematically as connected to the display, the actual control from the pushbuttons is via the microcontroller 5.040. A power supply 5.048 and clock 5.050 are also connected to the controller.

The monitor can be adapted to monitor more than one sensor wire. The pushbuttons enable a user to control features of the system, and to reset the alarm.

Where the area being monitored is usually unattended or remote, communication equipment can be provided to relay the alarm to another location where the alarm can be observed. The communication can be carried by wireless, telephone, internet or other suitable communication link or network.

FIG. 6 schematically illustrates equipment containing the arrangement of FIG. 5.

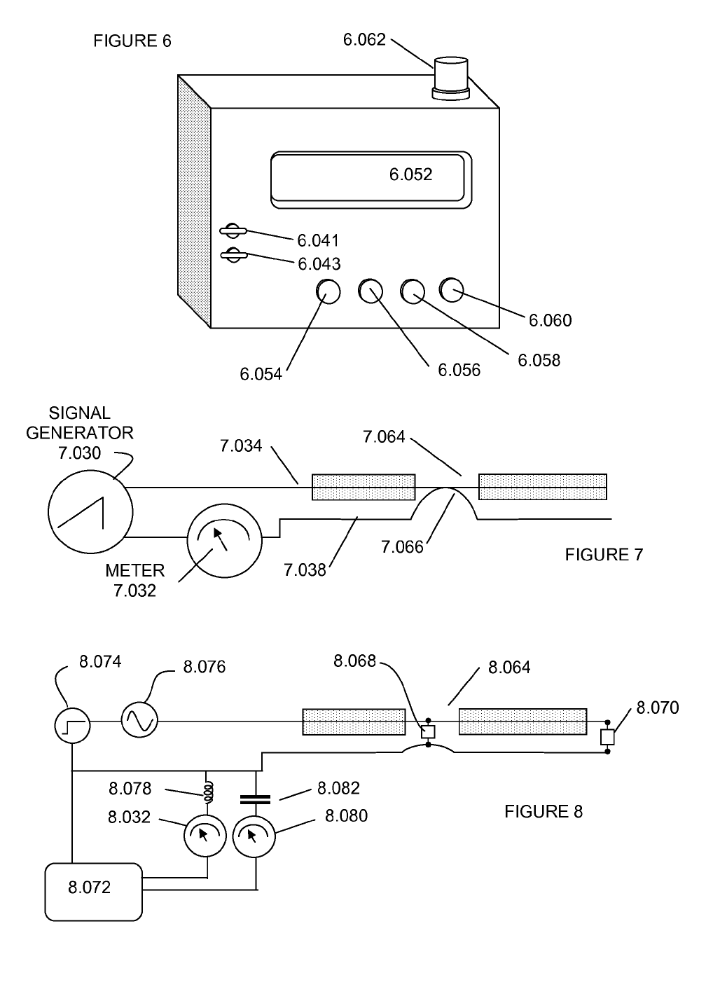

FIG. 7 schematically illustrates a sensor wire 7.034 from which part of the insulation has been dissolved, so the other wire 7.038 contacts the sensor wire at 7.066. As discussed above, both wires can have soluble insulation. In this arrangement, the distal ends of the wires are open circuit, so, in the absence of a fault, no current flows. However, when the insulation dissolves and the wires make contact at 7.066, current flows in the circuit. The amount of current is determined by the voltage from the signal generator 7.030 and the resistance of the wires 7.034 and 7.038 from the signal generator to the short circuit 7.066. This current is measured by ammeter 7.032, and the reading of the ammeter is an indication of the distance to the fault 7.066. Thus, the ammeter can be adapted to indicate length by providing a scale which is based on the linear resistance of the wire and the voltage.

FIG. 8 illustrates a further embodiment of the invention in which the sensor wires 8.034, 8.038 terminate with a terminating impedance 8.070. If the terminating impedance is a reactive element, such as a capacitor or inductor, the impedance of the line will be frequency sensitive since capacitive impedance ZC=1/jωC, and inductive impedance ZL=jωL.

This means that for a DC test voltage and capacitive termination, the steady state impedance is infinite, while for an alternating signal, the capacitive impedance ZC is added “transversely” (at 90°) to the resistance. Ignoring the line capacitance, with a sufficiently high frequency, capacitive termination impedance can be ignored. Z=R1+(R2*ZC)/(R2+ZC), where R1 is the resistance of the sensor wires on the meter side of the fault, and R2 is the resistance of the sensor wire on the other side of the fault. Hence R1+R2 is the total resistance of the sensor wire.

In this embodiment, it is assumed that the fault produces a resistive impedance 8.068.

Thus, where there is a resistive fault with a capacitive termination, for a DC input signal, the measured resistance is RD=(R1+R4), as ZC is infinite. For high frequency, the measured impedance is approximately RH=(R1+(R2*R4)/(R2+R4)) as ZC is negligible. Given that the sensor wire impedance RS=(R1+R2) is known from the length of the wire and its linear resistance, and the impedance can be measured for DC and high frequency, the three simultaneous equations can be solved for three unknowns, R1, R2, and R4. A similar analysis can be performed for an inductive termination. Of course, in practice, the line presents a complex impedance.

Hence, with a reactive termination, by applying two test signals to the sensor wire, a DC signal from a DC signal generator 8.074, and a high frequency signal from a hf signal generator 8.076, the location of the fault can be determined with reasonable accuracy even when the fault is a resistive contact using appropriate DC and hf detectors 8.032 and 8.080. With suitable filtering such as choke 8.78 and capacitor 8.082 and corresponding DC and hf detectors, the DC and hf signals can be applied simultaneously and corresponding readings taken simultaneously.

In an alternative arrangement, the impedance 8.070 can represent a short circuit fault located between the first impedance fault 8.068 and the end of the detector wire. In this case, the monitor can be programmed using an impedance network algorithm, based, for example, on Thevenin's theorem or other appropriate impedance network analysis tool, to calculate the impedance values.

Calibration of the system is preferably carried out while the cable is at its lowers operating temperature or while it is unloaded and at the lowest ambient temperature, as this will provide a minimum impedance measurement. Preferably, the cable is monitored for a period of time, for example one or two days, and the readings analysed to determine a minimum value or an average value, and this value can be used as a threshold reference value. Thus, if a measurement falls below this value, or falls below this value by a predetermined amount, an alarm can be initiated.

The cable can be monitored periodically to identify long term trends in the moisture characteristics of the cable.

A series of measurements taken over the long term can provide a record of the drift in the insulation characteristics of the soluble insulation from a long term average of the measurements.

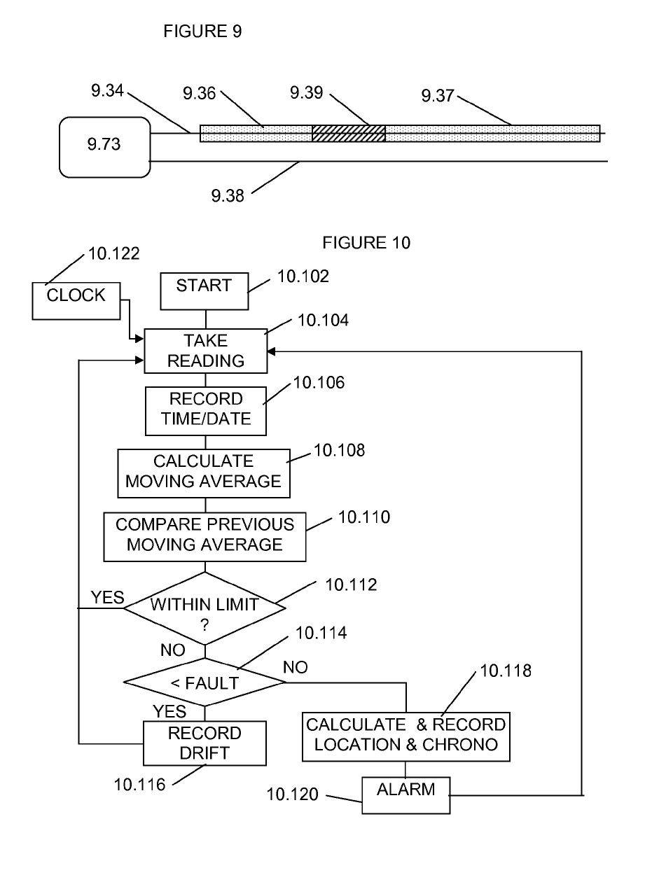

FIG. 9 illustrates a system in which the sensing cable has a bypass segment 9.39, ie, a region in which the insulation on the sensing cable is not soluble. The sensing cable has a first segment 9.36 and a third segment 9.037 which have soluble insulation, but the intermediate segment 9.079 has insoluble insulation. This may be done because the bypass segment may be located near, for example a source of significant temperature fluctuations, so that the impedance of that segment may fluctuate over a short time period, and this relatively rapid fluctuation in impedance may be misinterpreted by the monitor 9.073 as a leakage fault. The wire in the bypass segment may also have a significantly lower resistivity so any fluctuation in resistance in the bypass will not be significant. For example, the bypass wire can be of copper, while the sensing wire can be of stainless steel, which has a resistivity several orders of magnitude greater than copper. Such a bypass can be located in a region of a building which is subject to condensation which is calculated not to cause damage.

Alternatively, the monitor can be programmed to identify the temperature induced impedance fluctuations and recognize that they do are not constitute a fault. In this case, the bypass segment can still include soluble insulation.

FIG. 10 illustrates a method of operating a water monitoring system in accordance with an embodiment of the invention. In a first step, the process commences at 10.102, and, under the control of a clock 10.122, a measurement is taken and stored in memory 10.104 with the time and date information at 10.106. For an initial reading, the memory of the monitor will not contain any measurement values. However, after the initial cycle, the system can build up a moving average (10.108) or contain sequential measurements. Each subsequent measurement is compared with the calibration value or the moving average at 10.110, and, if it is within predetermined limits at 10.112, the system is considered good, and the next measurement cycle is enabled. However, if the measurement is outside the predetermined limits, the measurement can be further analysed at 10.144 to decide whether it is an indication of drift or of a fault. If it is determined to be an indication of drift in the insulation characteristics, this is recorder at 10.116. However, if a fault is indicated, the location is calculated and recorded together with the chronological information at 10.118, an alarm is initiated at 1.120, and the system then steps back in preparation for the next measurement cycle.

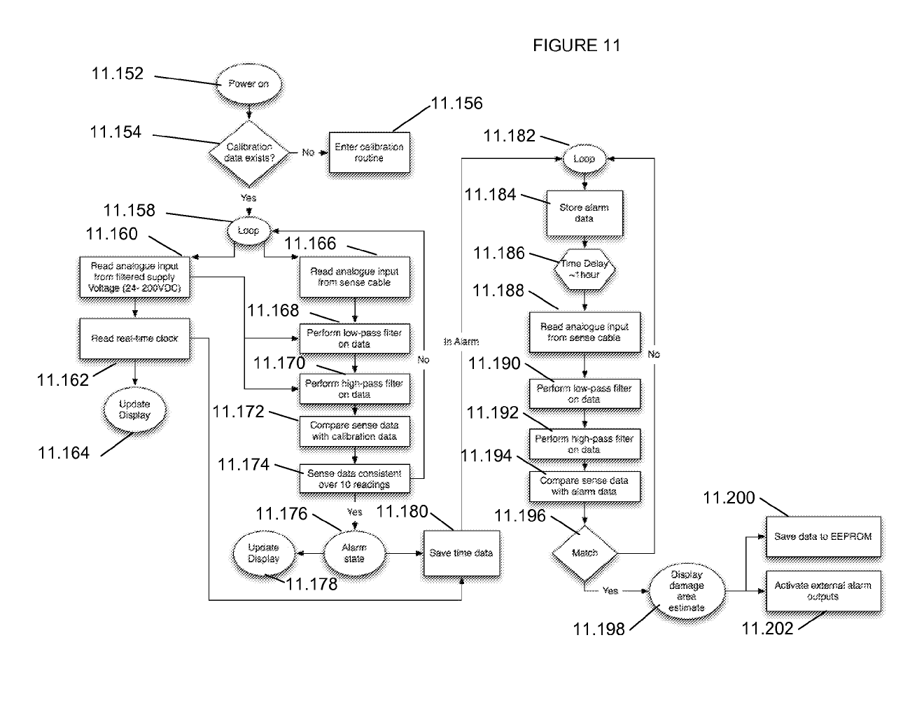

In the method illustrated in FIG. 11, an initial check is made for calibration data at 11.154, then the analog voltage is checked at 11.160 together with the time clock at 11.162 and the stored and displayed information is updated. At 11.166 the analogue input from the sensor cable is read, and filtered at 11.168 and 11.170, before comparison with the calibration data at 11.172. If the sensing data indicating a fault is not consistently reported over a number of readings, the system steps back to the loop point 11.158. If the sensing data indicating a fault is consistently reported over a number of readings, for example 10, then an alarm is generated at 11.176, the display updated at 11.178, and the time data stored at 11.180. The alarm data is stored at 11.184.

After a time delay, 11.186, the analogue input from the sense cable is read at 11.188, filtered at 11.190 & 11.192 and compared with the alarm data at 11.194. If there is no match at 11.196, the system steps back to loop point 11.182. If there is a match, the location of the fault is calculated and displayed at 11.198, the fault data stored in memory at 11.200, and the alarm actuated at 11.202.

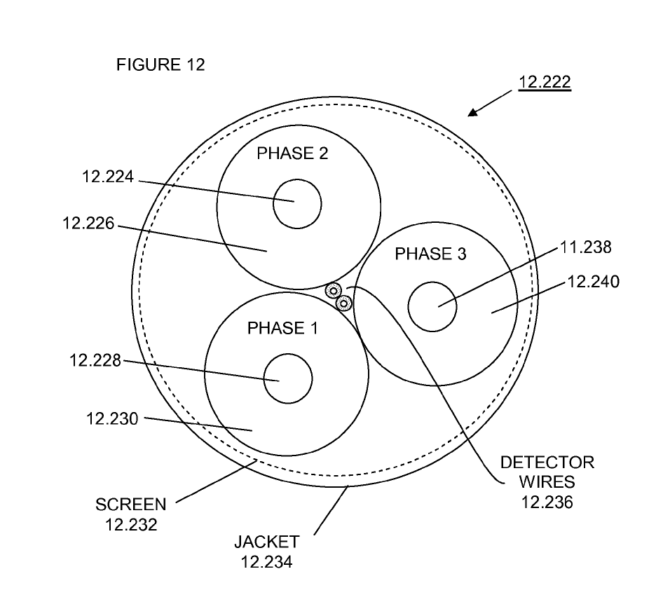

FIG. 12 illustrates a cross section of a three core cable 12.222 having insulated cores 12.224/12.226, 12.228/12.239, & 12.238/12.240, a screen 12.232, a jacket 12.234, and a two wire water detector cable 12.236.

The detector cable 12.236 is located in the interstice between the insulated cores, so water which penetrates to the interior of the cable will be detected by the detector cable 12.236.

In power cable applications, the sensor wire can be several hundred metres or more long.

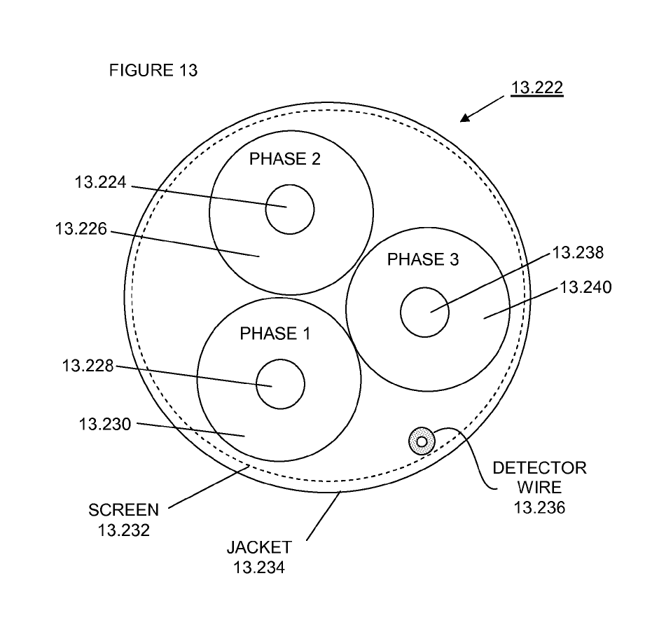

FIG. 13 illustrates a similar cable arrangement to that of FIG. 12, except that a single water detector wire 13.236 is used, and located adjacent to the screen 13.232. In this case, the screen is used as the return wire.

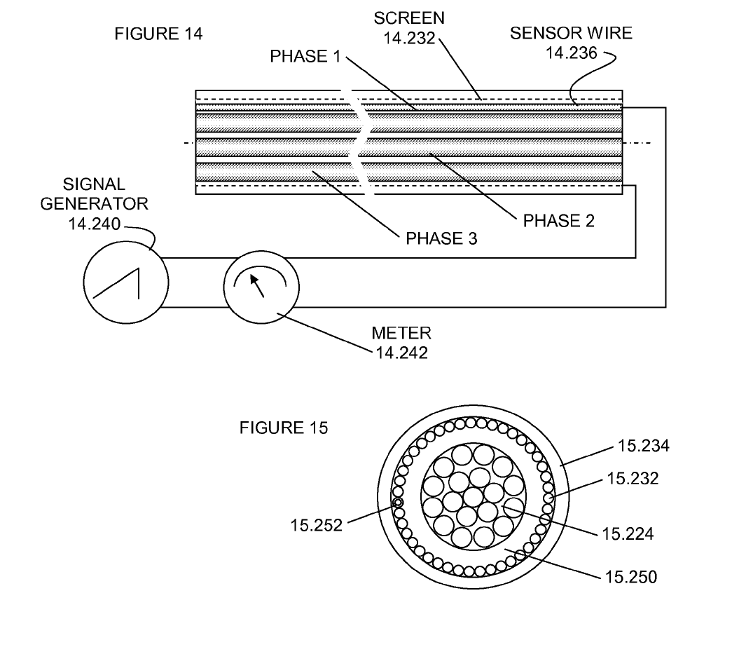

FIG. 15 illustrates a section of a single core cable with a water sensing wire in the screen 15.232. The cable has a core 15.224 with an insulating layer 15.250 surrounded by the screen 15.232, and an outer jacket 15.234. The screen is formed of a plurality of conductor wires, such as copper or aluminium which are helically wound. A water detection wire 15.252 is substituted for one of the wires in the screen. When the soluble jacket of the water detector wire dissolves, the detector conductor wire can contact the adjacent screen wires. This arrangement enables the penetration of the outer jacket 15.234 to be detected. In further embodiments, two or more detector wires can be incorporated into the screen 15.232.

FIG. 14 is a schematic block diagram of a water ingress detection system according to an embodiment of the invention. The power cable has three cores and a single detector wire 14.236 is located adjacent to the screen 14.232. At the monitor end, the screen and the detector wire are connected to a monitor system including a signal generator 14.240 and a signal detector 14.242. For example, the generator can generate a DC pulse, and the signal detector can measure the resulting current. If the cable is intact, and the distal end of the detector wire 14.036 and the screen 14.232 is an open circuit, no current should be detected. However, if the soluble insulation of the detector wire has been dissolved at some point along the length of the detector wire, a current will flow. the current will be inversely proportional to the distance along the cable from the monitor end, and will be proportional to the resistivity of the detector wire conductor. Thus a calculation of the distance of the fault from the monitor end of the cable can be made.

At joints, short lengths of the special insulated wire are used to maintain the continuity and also provide monitoring of the joint. Depending on the type of cable, special sensing wires are adopted. As an example, for Medium Voltage or High Voltage cable, the sensing wire can be a high strength, specially insulated wire, included together with screen wires or copper tape over the conductor screen and this wire is sufficiently robust for manufacture and handling.

The soluble insulation material is designed to ensure that in normal operation the material will not be affected by a small amount of moisture that may be present in service.

Because the detector wire jacket is water-soluble, the normal water cooled extrusion process cannot be used during the manufacture of the detector cable. Accordingly, after extruding the soluble jacket onto the detector wire the jacketed detector wire is cooled in air or in a liquid trough which contains a liquid which does not affect the jacket.

As mentioned above for condition monitoring an electronic monitoring and fault reporting system can be attached to the sensing wire in each cable.

This electronic monitoring module can be powered from a standard power outlet or remote battery supply and can be daisy chained for the monitoring of multiple cables. Each module contains a custom micro-controller, high accuracy analogue to digital converters, filtering components, alarm outputs, large memory space, easy to read LCD display and real-time clock.

If damage to a cable occurs, the monitor module measures the change of cable properties in real time, compares these values against ‘known good’ cable and logs an error code with a time and date stamp. This information is displayed to service personnel on the embedded LCD display. Due to the nature of the sensing cable, the position of the damage can be estimated (generally with sub-metre accuracy). It should be noted that the damage can manifest itself over a period of time and while the control electronics will log a fault immediately, the system will not necessarily show a fault location straight away. Generally the system will stabilise the fault condition and show the position of the damage after a period of several minutes to several hours, depending on the severity of the damage and the amount of water ingress. Fault conditions are maintained in memory by the module in the event of power failure.

In addition to displaying fault conditions on the modules built in display, data is available to the sub-station SCADA system (Supervisory Control And Data Acquisition) via relay output or optionally data can be sent via GSM for off site monitoring.

In one embodiment the cable braid (earth shield) is attached to circuit test equipment ground by half of a Wheatstone bridge, for example, at 5.042 in FIG. 5. This ensures that the system is fully isolated as substation earth and cable ground can be different.

The other half of the bridge is supplying reference voltage to second ADC channel to offset instantaneous noise induced on sense cable with respect to +24VDC.

AC noise is removed by passively filtering (Inductor) the input signal from the sense cable.

A 16 Bit ADC (analog-to-digital converter) is used to sample (24VDC) signal, Sense Signal from the above steps and is fed with a precision voltage source as a reference.

A micro-controller reads ADC at up to 50 Hz.

High and low pass filtering is performed after reading averaging to further reduce sporadic readings.

The following information can now be calculated. Total cable resistance, Power supply noise floor, and by performing readings over a period of time change in resistance with respect to time can be determined.

The start time for this data is stored for further reference. If any of the above factors change, the change is stored in EEPROM and, depending on the magnitude of the change, a fault is flagged.

Once a fault is detected, the system goes into an ‘observation’ mode which basically looks at the change in resistance ΔR and when the change slows (change becomes linear) the fault location is logged and displayed on the systems LCD display.

The sensing wires can be incorporated, for example, in single core and 3 core MV and HV cables.

For three core cables, it has been found that the water swellable tapes applied at the area of the screens do not limit the progress of water along the cable as well as it does for the single core designs, so more material is often required. Hence in this case water sensing becomes very important if long lengths of cable are not to become water logged and water is then able to enter the joints.

There are also very significant advantages in using water sensing in cables which have an aluminium foil in contact with copper wires. These cables are replacing lead sheathed cable as a low cost means of ensuring that the cables are radially protected against moisture entry and thus avoid “water treeing” problems. However these moisture barrier design cables are very vulnerable to the risk of corrosion. When moisture enters under the metallic foil, galvanic action occurs which can corrode the aluminium tape with serious consequences.

Instead of using an individual monitor for each cable, a monitor can be adapted to be connected to a plurality of cables and to poll each cable, and record results in an associative manner indicating the results relevant for each cable, together with date information.

In this specification, reference to a document, disclosure, or other publication or use is not an admission that the document, disclosure, publication or use forms part of the common general knowledge of the skilled worker in the field of this invention at the priority date of this specification, unless otherwise stated.

In this specification, terms indicating orientation or direction, such as “up”, “down”, “vertical”, “horizontal”, “left”, “right” “upright”, “transverse” etc. are not intended to be absolute terms unless the context requires or indicates otherwise. These terms will normally refer to orientations shown in the drawings.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A moisture detector monitor comprising:
a signal source connectable to a detector cable to apply a measurement signal to the detector cable;
a monitor including impedance measuring means to periodically or continuously measure the impedance of the cable; and processor means to determine whether the current measurement is within predetermined limits.

2. A moisture detector monitor as claimed in claim 1, including memory means containing a series of impedance measurements.

3. A monitor as claimed in claim 2, including comparison means comparing a current impedance measurement with a previously stored value.

4. A monitor system as claimed in claim 1, wherein the processor means is programmed to calculate the location of a low impedance fault on the insulated wire.

5. A monitor system as claimed in claim 1, including an impedance bridge connecting the return path wire and the impedance measuring means.

6: A monitor system as claimed in claim 1, including a successive approximation analog-to-digital converter.

7. A moisture ingress monitor system comprising:
one or more moisture detection wires having soluble insulation;
a return path; and
a monitor as claimed in claim 1 to which the detection wire and return path are connected.

8. A water ingress detector comprising:
a DC source; and
a DC detector, the detector being a bell or LED.

9. A water soluble material comprising:
two or more components, and at least a first component and a second component, wherein the first component has a first solubility in water and the second component is insoluble in water or has a lower solubility than the first component.

10. A water soluble material as claimed in claim 8, wherein the second component acts as a solubility modifier for the material.

11. A water soluble material as claimed in claim 9, wherein the ratio of the first and second components is adjusted to control the overall solubility of the material.

12. A water soluble material as claimed in claim 9, wherein the second material is a plastics or polymer material.

13. A water soluble material as claimed in claim 12, wherein the second component has a higher molecular weight than the first component.

14. A water soluble material as claimed in claim 9, wherein the second component is nylon.

15. A water soluble material as claimed in claim 9, wherein the soluble material is vinyl alcohol or polyvinyl alcohol.

16. A material as claimed in claim 9, wherein the combination of the first and second material has a decomposition temperature greater than the melt temperature of the first material.

17. A water soluble material as claimed in claim 9, wherein the material is extrudable.

18. A moisture detection wire comprising:
at least a first wire having a water soluble coating, wherein the coating includes a material as claimed in claim 8.

19. A water detection cable including a pair of detection wires as claimed in claim 18, including first and second wires, the wires being coated with a water soluble material, the coated wires being in close proximity.
